(19) United States
(12) Patent Application Publication
(10) Pub. No.: US 2023/0125738 A1
(43) Pub. Date: Apr. 27, 2023

(54) VIDEO DISPLAY DEVICE, VIDEO DISPLAY SYSTEM, VIDEO DISPLAY METHOD, AND PROGRAM

(71) Applicant: Sharp NEC Display Solutions, Ltd., Tokyo (JP)

(72) Inventor: Michitaka NAITOU, Tokyo (JP)

(21) Appl. No.: 17/911,330

(22) PCT Filed: Mar. 17, 2020
(86) PCT No.: PCT/JP2020/011695

§ 371 Date: Sep. 13, 2022

(51) Int. Cl. H04N 9/31

(52) U.S. Cl. CPC H04N 9/3179

(57) ABSTRACT

An image projection device includes: a calculation processor which executes a video mute operation on the basis of a video mute manipulation signal for requesting the video mute operation, determines whether or not a screensaver of video output equipment has been activated on the basis of a first signal input from the video output equipment, determines the presence or absence of a second signal to be input from the video output equipment, and determines whether or not information indicating the activation of the screensaver of the video output equipment has been stored. The calculation processor determines to continue the video mute operation when the video mute operation has been requested, when it is determined that there is no second signal, and when it is determined that the information indicating the activation of the screensaver of the video output equipment has been stored.

### TECHNICAL FIELD

The present invention relates to a video display device, a video display system, a video display method, and a program.

### BACKGROUND ART

Patent Literature 1 describes a display control device that reduces power consumption when a screensaver is operated. In technology described in Patent Literature 1, a microcomputer determines whether a screensaver or a normal screen has been used. When the microcomputer determines that the screensaver has been used, a luminance control signal is set for the screensaver and is transmitted to a backlight inverter. The backlight inverter limits electric power supplied to the backlight and limits an amount of light applied from the backlight.

Patent Literature 2 describes a display device for identifying a screensaver and a normal operation. In technology described in Patent Literature 2, it is identified whether or not an input video signal is based on a screensaver or a normal operation by detecting a signal level of a video signal and a power saving operation of a display device is performed on the basis of an identification result.

Patent Literature 3 describes a display device that receives and displays an image output from a computer in which a screensaver is mounted. In technology described in Patent Literature 3, the display device prevents the screensaver from being activated in the computer by generating code information in which the screensaver does not work and transmitting the code information to the computer at prescribed time intervals.

Patent Literature 4 describes a projection system that controls an operation of a screensaver of a computer in accordance with settings of a projector. In technology described in Patent Literature 4, screensaver control information is transmitted from the projector to the computer and therefore the screensaver is activated or deactivated in accordance with the settings of the projector.

Patent Literature 5 describes a computer that controls the luminance of a projector in accordance with a state of a computer. In technology described in Patent Literature 5, the computer determines whether or not a screensaver has been activated, generates control information for reducing the luminance of the projector when the screensaver has been activated, and transmits the control information to the projector.

Incidentally, in Patent Literature 1 to 5, no video mute operation is disclosed. Thus, according to the technologies described in Patent Literature 1 to 5, it is difficult to appropriately determine whether or not the video mute operation is required to be continued in accordance with the presence or absence of activation of the screensaver and the like.

In a general projector, for example, a projector user or the like can perform a video mute manipulation for requesting a video mute operation using a remote controller or the like.

For example, when a video signal input from video output equipment such as a personal computer (PC) to the projector has changed to a non-signal state while the video mute operation by the projector is being executed, whether to continue a video mute operation or whether to cancel the video mute operation depends on the setting of the projector. There is also a projector in which there is no video mute continuation setting originally and a video mute operation is canceled when the video signal input from video output equipment to the projector changes to the non-signal state.

### CITATION LIST

### Patent Literatures

### [Patent Literature 1]

Japanese Unexamined Patent Application, First Publication No. 2003-271107

### [Patent Literature 2]

Japanese Unexamined Patent Application, First Publication No. 2002-351420

### [Patent Literature 3]

Japanese Unexamined Patent Application, First Publication No. 2008-070434

### [Patent Literature 4]

Japanese Unexamined Patent Application, First Publication No. 2008-077301

### [Patent Literature 5]

Japanese Unexamined Patent Application, First Publication No. 2008-083182

### SUMMARY OF INVENTION

### Technical Problem

When a process of setting the continuation of a video mute operation is enabled, the video mute operation can be continued even if a PC changes to a hibernation state as a merit. On the other hand, as a demerit, when a video signal has not been input from the PC to a projector, a screen of the projector is continued in the video mute state (full screen black display) instead of a non-signal state. Further, even if the video signal is input again from the PC to the projector, the video mute operation is continued, so that a projector user may misunderstand that a failure in which the video display of the projector cannot be performed has occurred.

An objective of the present invention is to provide a video display device, a video display system, a video display method, and a program capable of appropriately determining whether or not to continue a video mute operation according to whether or not a screensaver has been activated.

### Solution to Problem

A video display device according to one aspect of the present invention includes: a calculation processor configured to analyze a video signal input from video output equipment; and a display configured to display a video on the basis of the video signal input from the video output equipment, wherein the calculation processor executes a video mute operation on the basis of a video mute manipulation signal for requesting the video mute operation, determines whether or not a screensaver of the video output equipment has been activated on the basis of a first signal input from the video output equipment, determines the presence or absence of a second signal to be input from the video output equipment, and determines whether or not information indicating the activation of the screensaver of the video output equipment has been stored, and wherein the calculation processor determines to continue the video mute operation when the video mute operation has been requested, when it is determined that there is no second signal, and when it is determined that the information indicating the activation of the screensaver of the video output equipment has been stored.

A video display system according to one aspect of the present invention includes: the video display device; the video output equipment; and an input manipulator configured to transmit the video mute manipulation signal.

A video display method according to one aspect of the present invention includes: a display step of displaying a video on the basis of a video signal input from video output equipment; a mute operation execution step of executing a video mute operation on the basis of a video mute manipulation signal for requesting the video mute operation; a screensaver activation determination step of determining whether or not a screensaver of the video output equipment has been activated on the basis of a first signal input from the video output equipment; a second signal presence/absence determination step of determining the presence or absence of a second signal to be input from the video output equipment; an activation storage presence/absence determination step of determining whether or not information indicating the activation of the screensaver of the video output equipment has been stored; and a mute operation continuation determination step of determining whether or not to continue the video mute operation, wherein the mute operation continuation determination step includes determining to continue the video mute operation when the video mute operation has been requested, when it is determined that there is no second signal, and when it is determined that the information indicating the activation of the screensaver of the video output equipment has been stored.

A program according to one aspect of the present invention makes a computer implement: a display step of displaying a video on the basis of a video signal input from video output equipment; a mute operation execution step of executing a video mute operation on the basis of a video mute manipulation signal for requesting the video mute operation; a screensaver activation determination step of determining whether or not a screensaver of the video output equipment has been activated on the basis of a first signal input from the video output equipment; a second signal presence/absence determination step of determining the presence or absence of a second signal to be input from the video output equipment; an activation storage presence/absence determination step of determining whether or not information indicating the activation of the screensaver of the video output equipment has been stored; and a mute operation continuation determination step of determining whether or not to continue the video mute operation, wherein the mute operation continuation determination step includes determining to continue the video mute operation when the video mute operation has been requested, when it is determined that there is no second signal, and when it is determined that the information indicating the activation of the screensaver of the video output equipment has been stored.

### Advantageous Effects of Invention

According to the present invention, it is possible to appropriately determine whether or not to continue a video mute operation according to the presence or absence of activation of a screensaver.

### BRIEF DESCRIPTION OF DRAWINGS

FIG. 1 is a block diagram showing an example of a schematic configuration of a video display system according to a first embodiment.

FIG. 2 is a flowchart for describing an example of a process executed in the video display system of the first embodiment.

FIG. 3 is a block diagram showing an example of a schematic configuration of a video display system of a second embodiment.

FIG. 4 is a flowchart for describing an example of a process executed in the video display system of the second embodiment.

FIG. 5 is a block diagram showing an example of a schematic configuration of a video display device of a third embodiment.

FIG. 6 is a block diagram showing an example of a schematic configuration of a video display system of a fourth embodiment.

FIG. 7 is a flowchart for describing an example of a process executed in the video display system of the fourth embodiment.

### DESCRIPTION OF EMBODIMENTS

Hereinafter, embodiments of a video display device, a video display system, a video display method, and a program of the present invention will be described with reference to the drawings.

### First Embodiment

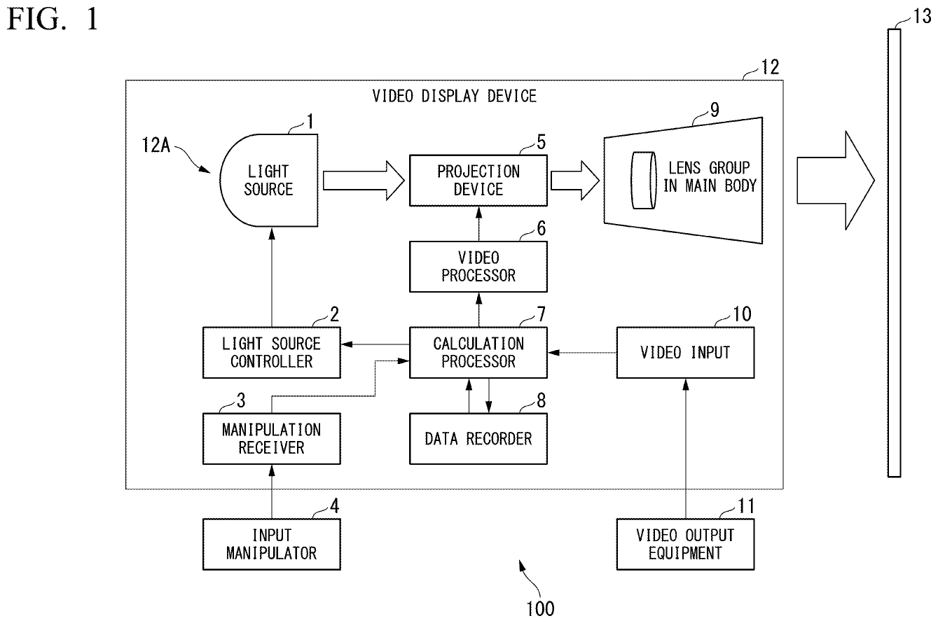

FIG. 1 is a block diagram showing an example of a schematic configuration of a video display system 100 of a first embodiment.

In the example shown in FIG. 1, the video display system 100 includes video output equipment 11, a video display device 12, a video projection target 13, and an input manipulator 4.

The video output equipment 11 is, for example, a PC or the like. The video output equipment 11 outputs a video signal (for example, an analog video signal or a digital video signal) to the video display device 12 via, for example, a video cable (not shown).

The video output equipment 11 has a screens aver function as a power-saving function. When the state in which the operation for the video output equipment 11 is not performed continues, the screensaver of the video output equipment 11 is activated. During the activation of the screensaver of the video output equipment 11, the video signal is output from the video output equipment 11 to the video display device 12. The video signal output from the video output equipment 11 while the screens aver is being activated includes a horizontal/vertical synchronization signal of a video.

When the state in which the operation for the video output equipment 11 is not performed further continues, a further power-saving function of the video output equipment 11 works and the video output equipment 11 is in a hibernation state. When the video output equipment 11 is in the hibernation state, the video output equipment 11 stops the output of the video signal to the video display device 12. That is, when the video output equipment 11 is in the hibernation state, the horizontal/vertical synchronization signal of the video is not output from the video output equipment 11.

The video display device 12 is, for example, a projector. The video display device 12 projects a video onto the video projection target 13 on the basis of a video signal input from the video output equipment 11.

The video projection target 13 is, for example, a screen, a whiteboard, or the like. The input manipulator 4 is, for example, a remote controller of the video display device 12. For example, the input manipulator 4 receives a request for a video mute operation of a user of the video display device 12 and transmits a video mute manipulation signal for requesting the video mute operation to the video display device 12.

Although the input manipulator 4 is a remote controller of the video display device 12 in the example shown in FIG. 1, the input manipulator 4 is an input (for example, a push-down key, a push-down button, or the like) provided in the video display device 12 in another example.

In the example shown in FIG. 1, the video display device 12 includes a video input 10, a manipulation receiver 3, a data recorder 8, a calculation processor 7, and a display 12A.

A video signal output by the video output equipment 11 is input to the video input 10. The video input 10 transmits the input video signal to the calculation processor 7.

The manipulation receiver 3 receives the video mute manipulation signal transmitted by the input manipulator 4 and transmits the video mute manipulation signal to the calculation processor 7.

The data recorder 8 stores a set value of the video display device 12, information indicating various types of states of the video display device 12, and the like.

The calculation processor 7 processes a basic operation of the video display device 12. Specifically, for example, the calculation processor 7 receives a video signal transmitted by the video input 10 (the video signal includes information indicating, for example, luminance, an input level, or the like) and receives a video mute signal transmitted by the manipulation receiver 3 or the like. The calculation processor 7 analyzes the received video signal, the received video mute manipulation signal, and the like. Also, the calculation processor 7 transmits a video signal to the display 12A. Further, the calculation processor 7 writes information to the data recorder 8, reads information from the data recorder 8, and the like.

The display 12A projects a video on the video projection target 13 based on the video signal input from the video output equipment 11. The display 12A includes a light source 1, a light source controller 2, a video processor 6, a projection device 5, and a lens group 9 in a main body.

For example, the light source 1 has a solid light source such as a high-power halogen lamp or laser. The light source controller 2 controls turn-on, turn-off, and the like of the light source 1 on the basis of a signal transmitted from the calculation processor 7. The video processor 6 performs a process such as electrical amplitude adjustment (luminance or contrast adjustment) of the video projected onto the video projection target 13 on the basis of a signal transmitted from the calculation processor 7. The projection device 5 is, for example, a liquid crystal panel when the video display device 12 is a liquid crystal type projector, a digital micromirror device (DMD) when the video display device 12 is a digital light processing (DLP) type projector, or the like. A signal transmitted from the video processor 6 is input to the projection device 5. The projection device 5 functions as a display that displays a video on the basis of a video signal input from the video output equipment 11. The lens group 9 in the main body performs the enlargement of the video projected onto the video projection target 13 and the like.

The calculation processor 7 executes a video mute operation on the basis of a video mute manipulation signal received by the manipulation receiver 3 (“video mute” is also referred to as “video blank”, “full black screen display”, or the like).

The calculation processor 7 determines whether or not the screensaver of the video output equipment 11 has been activated on the basis of a video signal input from the video output equipment 11. The calculation processor 7 determines whether or not the screensaver of the video output equipment 11 has been activated using, for example, the technology described in Patent Literature 2. Specifically, the calculation processor 7 determines whether or not the screens aver of the video output equipment 11 has been activated by comparing luminance levels of four sides of an image indicated by a video signal (a first signal) input from the video output equipment 11.

When the calculation processor 7 determines the activation of the screensaver of the video output equipment 11, information indicating the activation of the screensaver of the video output equipment 11 is written in the data recorder 8. That is, the data recorder 8 stores the information indicating the activation of the screensaver of the video output equipment 11 when the screensaver of the video output equipment 11 has been activated.

The calculation processor 7 determines the presence/absence of a signal (a second signal) input from the video output equipment 11.

As described above, the video output equipment 11 in the hibernation state does not output a video signal (a second signal) (specifically, a horizontal/vertical synchronization signal of the video). Accordingly, when the horizontal/vertical synchronization signal (the second signal) of the video is not input from the video output equipment 11 (i.e., when there is no second signal input from the video output equipment 11), the calculation processor 7 may determine that the video output equipment 11 is in the hibernation state.

Specifically, when the manipulation receiver 3 receives a video mute manipulation signal (a signal for requesting the video mute operation), the calculation processor 7 executes a process of discarding information indicating the activation of the screens aver of the video output equipment 11 stored in the data recorder 8 before the presence/absence of the second signal is determined.

Also, when the manipulation receiver 3 receives the video mute manipulation signal, the calculation processor 7 determines whether or not the screensaver of the video output equipment 11 has been activated before the presence/absence of the second signal is determined.

The calculation processor 7 determines whether or not the information indicating the activation of the screensaver of the video output equipment 11 has been stored in the data recorder 8.

The calculation processor 7 determines whether or not to continue the video mute operation.

Specifically, the calculation processor 7 determines to continue the video mute operation when the manipulation receiver 3 has received the video mute manipulation signal, when it is determined that there is no second signal (for example, it is determined that the video output equipment 11 is in a hibernation state), and when it is determined that the information indicating the activation of the screensaver of the video output equipment 11 has been stored in the data recorder 8.

As a normal operation, the video display device 12 of the first embodiment performs non-signal display regardless of whether or not the video mute operation has been executed when the video signal has not been input from the video output equipment 11. However, if the screens aver of the video output equipment 11 is activated while the video mute operation is being executed, the calculation processor 7 performs a process so that the video mute operation is continued. The calculation processor 7 determines whether or not to continue the video mute operation according to the determination of whether or not the screensaver of the video output equipment 11 has been activated (i.e., whether or not information indicating the activation of the screensaver of the video output equipment 11 has been stored in the data recorder 8).

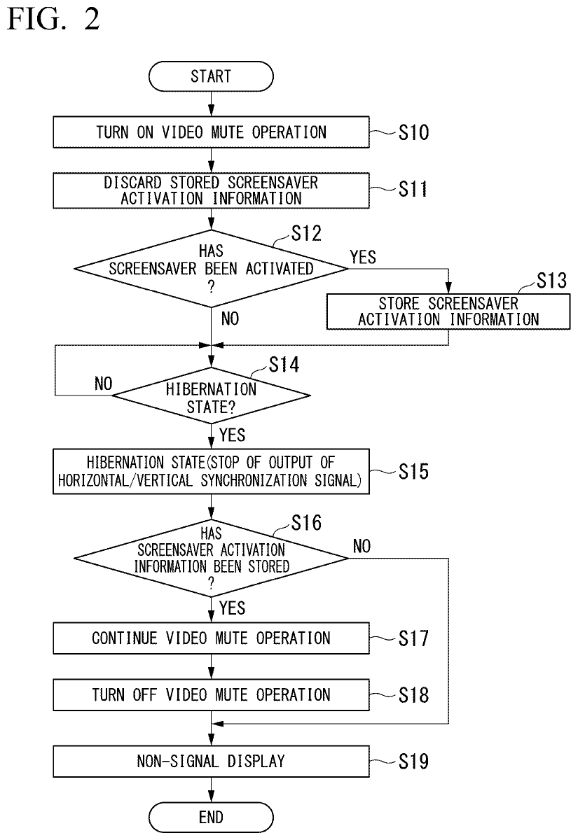

FIG. 2 is a flowchart for describing an example of a process executed in the video display system 100 of the first embodiment.

In the example shown in FIG. 2, in step S10, a user of the video display device 12 issues a request for a video mute operation. That is, the input manipulator 4 receives the request for the video mute operation and the calculation processor 7 executes the video mute operation.

Subsequently, in step S11, the calculation processor 7 executes a process of discarding the information indicating that the screensaver of the video output equipment 11 stored in the data recorder 8 has been activated.

Subsequently, in step S12, the calculation processor 7 determines whether or not the screensaver of the video output equipment 11 has been activated. When the screens aver of the video output equipment 11 has been activated, the process proceeds to step S13. On the other hand, when the screensaver of the video output equipment 11 has not been activated, the process proceeds to step S14.

In step S13, the data recorder 8 stores the information indicating the activation of the screensaver of the video output equipment 11. The process proceeds to step S14.

In step S14, the calculation processor 7 determines whether or not there is a second signal input from the video output equipment 11 (for example, determines whether or not the video output equipment 11 is in a hibernation state). When there is no second signal (for example, when the video output equipment 11 is in the hibernation state), the process proceeds to step S15. On the other hand, when there is a second signal (for example, when the video output equipment 11 is not in the hibernation state), step S14 is iteratively executed.

In step S15, the video output equipment 11 is in the hibernation state (the output of the horizontal/vertical synchronization signal from the video output equipment 11 stops).

Subsequently, in step S16, the calculation processor 7 determines whether or not the information indicating the activation of the screensaver of the video output equipment 11 has been stored in the data recorder 8. When the information indicating the activation of the screens aver of the video output equipment 11 has been stored in the data recorder 8, the process proceeds to step S17. On the other hand, when the information indicating that the screensaver of the video output equipment 11 has not been activated has been stored in the data recorder 8, the process proceeds to step S19.

In step S17, the calculation processor 7 continues the video mute operation.

Subsequently, in step S18, the user of the video display device 12 issues a request for stopping the video mute operation. That is, the input manipulator 4 receives the request for stopping the video mute operation, the calculation processor 7 stops the video mute operation, and the process proceeds to step S19.

In step S19, the video display device 12 performs a non-signal display process.

For example, the video display device 12 of the first embodiment is used by a presenter who makes a presentation at a conference or the like. If the presenter inputs the video signal of the video output equipment 11 to the video display device 12, when the presenter intentionally hides the video of the video output equipment 11, a manipulation for requesting a video mute operation is input to the input manipulator 4 (video mute ON) and the calculation processor 7 executes the video mute operation.

The calculation processor 7 of the video display device 12 executes a process of discarding the information indicating that the screensaver of the video output equipment 11 stored in the data recorder 8 has been activated at a timing when the presenter has turned on the video mute operation.

If a state in which the video output equipment 11 is not manipulated continues for a while, the screensaver is activated as a power-saving function of the video output equipment 11. The calculation processor 7 determines that the screensaver has been activated on the basis of luminance levels of four sides of an image indicated by the video signal input from the video output equipment 11 and the data recorder 8 stores information indicating that the screensaver has been activated.

When the state in which the video output equipment 11 is left unattended continues, the further power-saving function of the video output equipment 11 works and the video output equipment 11 shifts to the hibernation state in which the video output is stopped. When the video output equipment 11 is in the hibernation state, the output of the video signal from the video output equipment 11 to the video display device 12 is stopped and the horizontal/vertical synchronization signal of the video is not output from the video output equipment 11.

When the information indicating that the screensaver has been activated remains in the data recorder 8 of the video display device 12, the video display device 12 does not perform a non-signal display process and the calculation processor 7 continues the video mute operation. When the presenter wants to cancel the video mute operation, the presenter inputs a manipulation for requesting the cancelation of the video mute operation to the input manipulator 4 (video mute OFF) and the calculation processor 7 stops the video mute operation.

When the information indicating that the screensaver has been activated does not remain in the data recorder 8 of the video display device 12, the calculation processor 7 stops the video mute operation (automatically cancels the video mute operation), and the video display device 12 performs a non-signal display process.

In the video display device 12 of the first embodiment, when a mouse of the video output equipment 11 or the like is subsequently operated and the output of the video signal from the video output equipment 11 to the video display device 12 is restored, the display of the video display device 12 is switched from the non-signal display to the signal display because the calculation processor 7 does not continue the video mute operation.

As described above, in the video display system 100 of the first embodiment, it is possible to automatically determine the continuation of the video mute operation using the screensaver function and the hibernation state only with a video cable. It is unnecessary to set the presence or absence of continuation.

Also, because the fixed setting for continuing the video mute operation is not used, the video mute operation does not continue. As a result, there is no erroneous determination of a signal discrimination failure.

### Second Embodiment

Hereinafter, a second embodiment of a video display device, a video display system, a video display method, and a program of the present invention will be described.

A video display system 100 of the second embodiment is configured like the video display system 100 of the first embodiment described above, except for differences to be described below. Therefore, according to the video display system 100 of the second embodiment, effects similar to those of the video display system 100 of the first embodiment described above can be obtained, except for the differences to be described below.

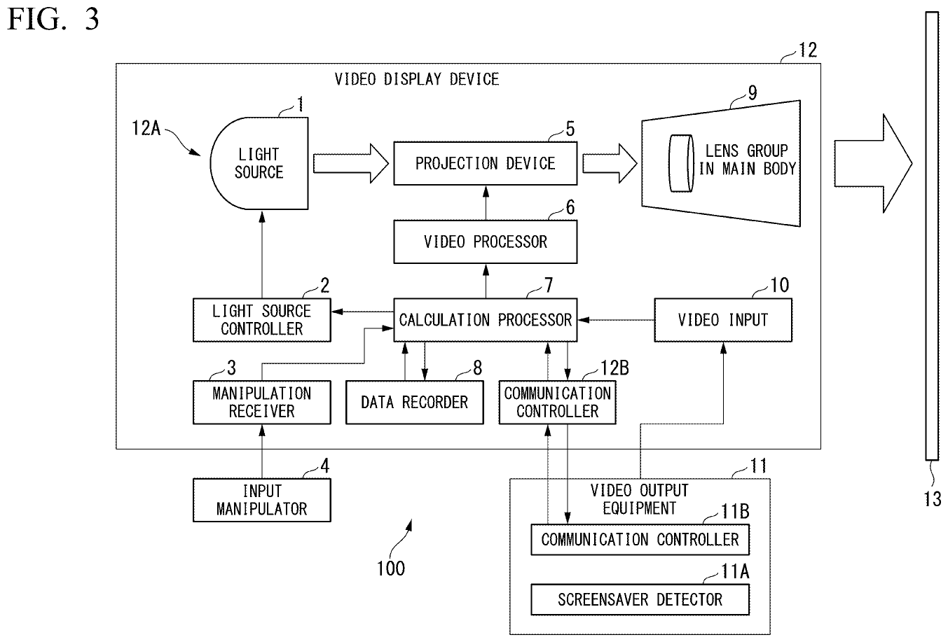

FIG. 3 is a block diagram showing an example of a schematic configuration of the video display system 100 of the second embodiment.

In the example shown in FIG. 3, the video output equipment 11 is, for example, a PC. The video output equipment 11 outputs a video signal (for example, an analog video signal or a digital video signal) or the like to a video display device 12 via, for example, a video cable.

The video output equipment 11 includes a screensaver detector 11A and a communication controller 11B.

The screensaver detector 11A detects the activation of the screensaver. For example, a screensaver detection-specific resident application or the like installed in the video output equipment 11 functions as the screensaver detector 11A.

The communication controller 11B transmits a signal indicating the activation of the screensaver detected by the screensaver detector 11A to the video display device 12.

In the example shown in FIG. 3, the video display device 12 is, for example, a projector. A video signal, a signal indicating the activation of the screensaver, and the like are input from the video output equipment 11 to the video display device 12. The video display device 12 projects a video onto the video projection target 13 on the basis of the video signal input from the video output equipment 11.

In the example shown in FIG. 3, the video display device 12 includes a video input 10, a manipulation receiver 3, a data recorder 8, a calculation processor 7, a display 12A, and a communication controller 12B.

The communication controller 12B receives a signal indicating the activation of the screensaver transmitted by the communication controller 11B. Also, the communication controller 12B transmits the signal indicating the activation of the screensaver to the calculation processor 7.

The calculation processor 7 receives and analyzes the signal indicating the activation of the screensaver transmitted by the communication controller 12B.

In the example shown in FIG. 3, the calculation processor 7 determines whether or not the screensaver of the video output equipment 11 has been activated on the basis of the signal (a first signal) indicating the activation of the screensaver input from the communication controller 11B of the video output equipment 11.

When the calculation processor 7 determines the activation of the screensaver of the video output equipment 11, information indicating the activation of the screensaver of the video output equipment 11 is written in the data recorder 8.

When the manipulation receiver 3 has received the video mute manipulation signal, the calculation processor 7 determines whether or not the screensaver of the video output equipment 11 has been activated on the basis of the signal indicating the activation of the screensaver input from the communication controller 11B of the video output equipment 11 before determining whether or not the video output equipment 11 is in the hibernation state.

The calculation processor 7 determines to continue the video mute operation when the manipulation receiver 3 has received the video mute manipulation signal, when it is determined that there is no second signal (for example, when it is determined that the video output equipment 11 is in a hibernation state), and when it is determined that the information indicating the activation of the screensaver of the video output equipment 11 has been stored in the data recorder 8.

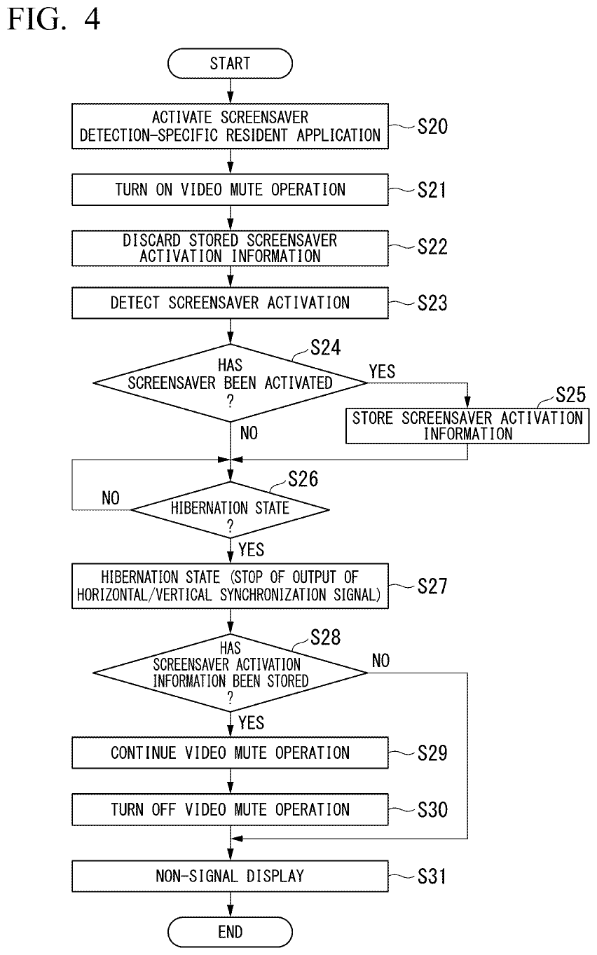

FIG. 4 is a flowchart for describing an example of a process executed in the video display system 100 of the second embodiment.

In the example shown in FIG. 4, in step S20, a user of the video display device 12 activates the screensaver detection-specific resident application of the video output equipment 11.

Subsequently, in step S21, the user of the video display device 12 issues a video mute operation request, the input manipulator 4 receives the video mute operation request, and the calculation processor 7 executes the video mute operation.

Subsequently, in step S22, the calculation processor 7 executes a process of discarding the information indicating the activation of the screensaver of the video output equipment 11 stored in the data recorder 8.

Subsequently, in step S23, the screensaver detection-specific resident application of the video output equipment 11 functioning as the screensaver detector 11A detects the activation of the screens aver and the communication controller 11B transmits a signal indicating the activation of the screensaver to the video display device 12.

Subsequently, in step S24, the calculation processor 7 determines whether or not the screensaver of the video output equipment 11 has been activated on the basis of the signal indicating the activation of the screensaver input from the communication controller 11B of the video output equipment 11. When the screensaver of the video output equipment 11 has been activated, the process proceeds to step S25. On the other hand, when the screensaver of the video output equipment 11 has not been activated, the process proceeds to step S26.

In step S25, the data recorder 8 stores the information indicating the activation of the screensaver of the video output equipment 11. The process proceeds to step S26.

In step S26, the calculation processor 7 determines whether or not there is a second signal input from the video output equipment 11 (for example, determines whether or not the video output equipment 11 is in a hibernation state). When there is no second signal (for example, when the video output equipment 11 is in the hibernation state), the process proceeds to step S27. On the other hand, when there is a second signal (for example, when the video output equipment 11 is not in the hibernation state), step S26 is iteratively executed.

In step S27, the video output equipment 11 is in the hibernation state (the output of the horizontal/vertical synchronization signal from the video output equipment 11 stops).

Subsequently, in step S28, the calculation processor 7 determines whether or not the information indicating the activation of the screensaver of the video output equipment 11 has been stored in the data recorder 8. When the information indicating the activation of the screens aver of the video output equipment 11 has been stored in the data recorder 8, the process proceeds to step S29. On the other hand, when the information indicating the activation of the screensaver of the video output equipment 11 has not been stored in the data recorder 8, the process proceeds to step S31.

In step S29, the calculation processor 7 continues the video mute operation.

Subsequently, in step S30, the user of the video display device 12 issues a request for stopping the video mute operation, the input manipulator 4 receives the request for stopping the video mute operation, and the calculation processor 7 stops the video mute operation. The process proceeds to step S31.

In step S31, the video display device 12 performs a no-signal display process.

For example, the video display device 12 of the second embodiment is used by a presenter who makes a presentation at a conference or the like. The presenter activates the screensaver detection-specific resident application in advance on the video output equipment 11 used for the presentation.

If the presenter inputs the video signal of the video output equipment 11 to the video display device 12, when the presenter intentionally hides the video of the video output equipment 11, the presenter inputs a manipulation for requesting the video mute operation to the input manipulator 4 (video mute ON) and the calculation processor 7 executes the video mute operation.

The calculation processor 7 executes a process of discarding information indicating the activation of the screensaver of the video output equipment 11 stored in the data recorder 8 at a timing when the presenter has turned on the video mute operation.

If a state in which the video output equipment 11 is not manipulated continues for a while, the screensaver is activated as a power-saving function of the video output equipment 11. The screensaver detection-specific resident application detects the activation of the screens aver by monitoring the process of the video output equipment 11 and the communication controller 11B transmits a signal indicating the activation of the screensaver to the video display device 12.

The calculation processor 7 determines that the screensaver has been activated on the basis of the signal indicating the activation of the screensaver input from the communication controller 11B of the video output equipment 11 and the data recorder 8 stores information indicating that the screensaver has been activated.

If a state in which the video output equipment 11 is left unattended continues, the further power-saving function of the video output equipment 11 works and the video output equipment 11 shifts to the hibernation state in which the video output is stopped. When the video output equipment 11 is in the hibernation state, the output of the video signal from the video output equipment 11 to the video display device 12 is stopped and the horizontal/vertical synchronization signal of the video is not output from the video output equipment 11.

When the information indicating that the screensaver has been activated remains in the data recorder 8 of the video display device 12, the video display device 12 does not perform a non-signal display process and the calculation processor 7 continues the video mute operation. When the presenter wants to cancel the video mute operation, the presenter inputs a manipulation for requesting the cancelation of the video mute operation to the input manipulator 4 (video mute OFF) and the calculation processor 7 stops the video mute operation.

If the information indicating that the screensaver has been activated does not remain in the data recorder 8 of the video display device 12, the calculation processor 7 stops the video mute operation (automatically cancels the video mute operation) and the video display device 12 performs the non-signal display process.

In the video display device 12 of the second embodiment, when the mouse of the video output equipment 11 or the like is subsequently manipulated and the output of the video signal from the video output equipment 11 to the video display device 12 is restored, the display of the video display device 12 is switched from the non-signal display to the signal display because the calculation processor 7 does not continue the video mute operation.

### Third Embodiment

Hereinafter, a third embodiment of a video display device, a video display system, a video display method, and a program of the present invention will be described.

A video display device 12 of the third embodiment is configured like the video display device 12 of the first embodiment described above, except for differences to be described below. Therefore, according to the video display device 12 of the third embodiment, effects similar to those of the video display device 12 of the first embodiment described above can be obtained, except for the differences to be described below.

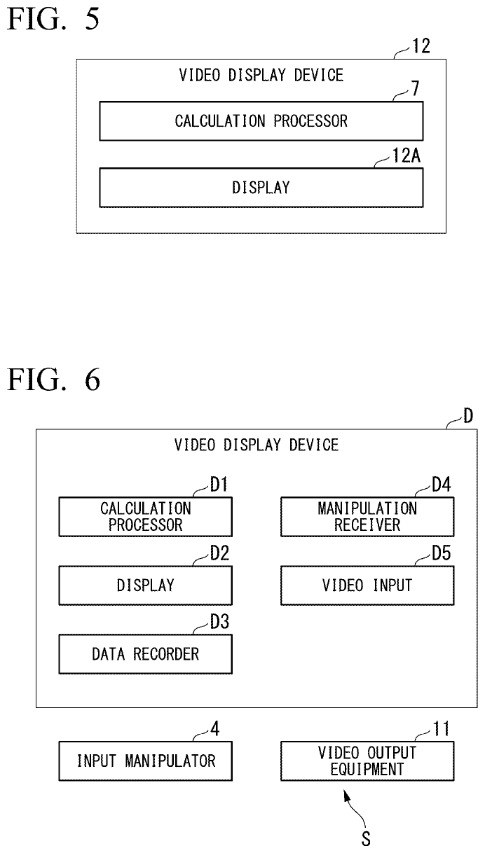

FIG. 5 is a block diagram showing an example of a schematic configuration of the video display device 12 of the third embodiment.

In the example shown in FIG. 5, the video display device 12 includes a calculation processor 7 and a display 12A. The calculation processor 7 analyzes a video signal input from video output equipment 11. The display 12A displays (projects) a video on the basis of the video signal input from the video output equipment 11.

The calculation processor 7 executes the video mute operation on the basis of the video mute manipulation signal for requesting the video mute operation. Also, the calculation processor 7 determines whether or not the screensaver of the video output equipment 11 has been activated on the basis of a signal (a first signal) input from the video output equipment 11. The calculation processor 7 determines the presence/absence of a signal (a second signal) input from the video output equipment 11. The calculation processor 7 may determine that the video output equipment 11 is in a hibernation state when there is no second signal input from the video output equipment 11. The calculation processor 7 determines whether or not information indicating the activation of the screens aver of the video output equipment 11 has been stored.

Specifically, the calculation processor 7 determines to continue the video mute operation when the video mute operation has been required, when it is determined that there is no second signal (for example, it is determined that the video output equipment 11 is in a hibernation state), and when it is determined that the information indicating the activation of the screens aver of the video output equipment 11 has been stored in the data recorder 8.

### Fourth Embodiment

Hereinafter, a fourth embodiment of a video display device, a video display system, a video display method, and a program of the present invention will be described.

A video display system S of the fourth embodiment is configured like the video display system 100 of the first embodiment described above, except for differences to be described below. Therefore, according to the video display system S of the fourth embodiment, effects similar to those of the video display system 100 of the first embodiment described above can be obtained, except for the differences to be described below.

FIG. 6 is a block diagram showing an example of a schematic configuration of the video display system S of the fourth embodiment.

In the example shown in FIG. 6, the video display system S includes video output equipment 11, a video display device D, and an input manipulator 4.

The video output equipment 11 is, for example, a PC or the like. The video output equipment 11 outputs a video signal (for example, an analog video signal or a digital video signal) to the video display device D via, for example, a video cable (not shown).

The video output equipment 11 has a screens aver function as a power-saving function. If a state in which a manipulation for the video output equipment 11 is not performed continues, the screens aver of the video output equipment 11 is activated. During the activation of the screensaver of the video output equipment 11, a video signal is output from the video output equipment 11 to the video display device D. The video signal output from the video output equipment 11 while the screens aver is being activated includes a horizontal/vertical synchronization signal of a video.

If the state in which the manipulation for the video output equipment 11 is not performed continues, the further power-saving function of the video output equipment 11 works and the video output equipment 11 is in a hibernation state. When the video output equipment 11 is in the hibernation state, the video output equipment 11 stops the output of a video signal to the video display device D. That is, when the video output equipment 11 is in the hibernation state, the horizontal/vertical synchronization signal of the video is not output from the video output equipment 11.

The video display device D is a display such as the display device described in Patent Literature 2. The video display device D displays a video on the display screen on the basis of a video signal input from the video output equipment 11.

The input manipulator 4 is, for example, a remote controller of the video display device D. The input manipulator 4 receives, for example, a request for a video mute operation of a user of the video display device D, and transmits a video mute manipulation signal for requesting the video mute operation to the video display device D.

Although the input manipulator 4 is a remote controller of the video display device D in the example shown in FIG. 6, the input manipulator 4 may be an input (for example, a push-down key, a push-down button, or the like) provided in the video display device D in another example.

In the example shown in FIG. 6, the video display device D includes a video input D5, a manipulation receiver D4, a data recorder D3, a calculation processor D1, and a display D2.

A video signal output by the video output equipment 11 is input to the video input D5. The video input D5 transmits the input video signal to the calculation processor D1.

The manipulation receiver D4 receives a video mute manipulation signal transmitted by the input manipulator 4 and transmits the video mute manipulation signal to the calculation processor D1.

The data recorder D3 stores a set value of the video display device D, information indicating various states of the video display device D, and the like.

The calculation processor D1 processes a basic operation of the video display device D. Specifically, for example, the calculation processor D1 receives the video signal transmitted by the video input D5 (the video signal includes information indicating, for example, luminance, an input level, and the like), the video mute manipulation signal transmitted by the manipulation receiver D4, and the like. The calculation processor D1 analyzes the received video signal, the received video mute manipulation signal, and the like. Also, the calculation processor D1 transmits the video signal to the display D2. Further, the calculation processor D1 writes information in the data recorder D3, reads information from the data recorder D3, and the like.

The display D2 displays a video on a display screen on the basis of the video signal input from the video output equipment 11.

The calculation processor D1 executes the video mute operation on the basis of the video mute manipulation signal received by the manipulation receiver D4.

Also, the calculation processor D1 determines whether or not the screensaver of the video output equipment 11 has been activated on the basis of a video signal (a first signal) input from the video output equipment 11. The calculation processor D1 determines whether or not the screens aver of the video output equipment 11 has been activated using, for example, the technology described in Patent Literature 2. Specifically, the calculation processor D1 determines whether or not the screensaver of the video output equipment 11 has been activated by comparing luminance levels of four sides of an image indicated by the video signal input from the video output equipment 11.

When the calculation processor D1 determines the activation of the screensaver of the video output equipment 11, information indicating the activation of the screensaver of the video output equipment 11 is written in the data recorder D3. That is, the data recorder D3 stores the information indicating the activation of the screensaver of the video output equipment 11 when the screens aver of the video output equipment 11 has been activated.

The calculation processor D1 determines the presence/absence of a signal (a second signal) input from the video output equipment 11.

As described above, the video output equipment 11 in a hibernation state does not output a video signal (the second signal) (specifically, a horizontal/vertical synchronization signal of the video). Therefore, when the horizontal/vertical synchronization signal of the video is not input from the video output equipment 11 (i.e., when there is no second signal input from the video output equipment 11), the calculation processor D1 may determine that the video output equipment 11 is in the hibernation state.

Specifically, when the manipulation receiver D4 has received the video mute manipulation signal (a signal for requesting the video mute operation), the calculation processor D1 executes a process of discarding information indicating the activation of the screens aver of the video output equipment 11 stored in the data recorder D3 before the presence/absence of the second signal is determined.

Also, when the manipulation receiver D4 receives the video mute manipulation signal, the calculation processor D1 determines whether or not the screensaver of the video output equipment 11 has been activated before the presence/absence of the second signal is determined.

The calculation processor D1 determines whether or not the information indicating the activation of the screensaver of the video output equipment 11 has been stored in the data recorder D3.

The calculation processor D1 determines to continue the video mute operation when the manipulation receiver D4 has received the video mute manipulation signal, when it is determined that there is no second signal (for example, it is determined that the video output equipment 11 is in a hibernation state), and when it is determined that the information indicating the activation of the screensaver of the video output equipment 11 has been stored in the data recorder D3.

The video display device D of the fourth embodiment performs a non-signal display process regardless of whether or not the video mute operation has been executed by the calculation processor D1 when the video signal has not been input from the video output equipment 11 as a normal operation. However, when the screens aver of the video output equipment 11 has been activated while the video mute operation is being executed by the calculation processor D1, the calculation processor D1 performs a process so that the video mute operation is continued. The calculation processor D1 determines whether or not to continue the video mute operation according to the determination of whether or not the screensaver of the video output equipment 11 has been activated (i.e., whether or not information indicating the activation of the screensaver of the video output equipment 11 has been stored in the data recorder D3).

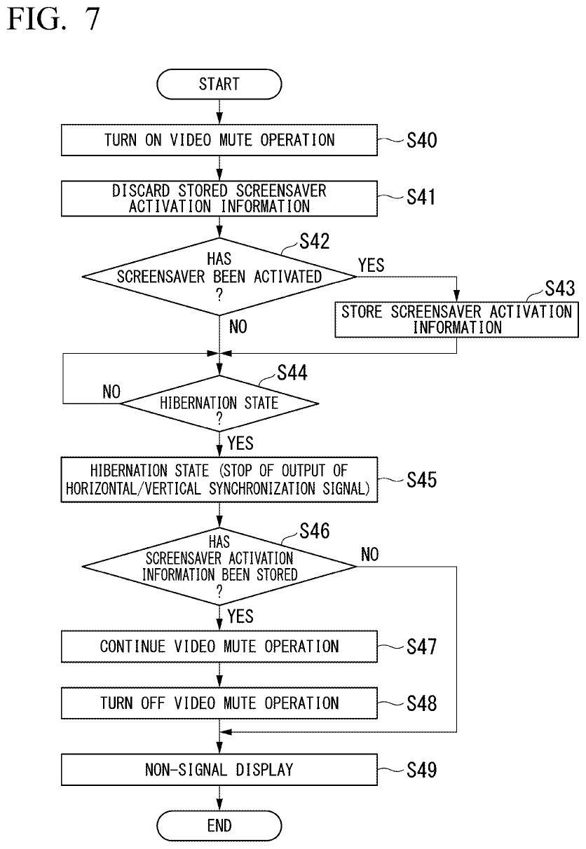

FIG. 7 is a flowchart for describing an example of a process executed in the video display system S of the fourth embodiment.

In the example shown in FIG. 7, in step S40, the user of the video display device D issues a request for the video mute operation. That is, the input manipulator 4 receives the request for the video mute operation and the calculation processor D1 executes the video mute operation.

Subsequently, in step S41, the calculation processor D1 executes a process of discarding information indicating the activation of the screensaver of the video output equipment 11 stored in the data recorder D3.

Subsequently, in step S42, the calculation processor D1 determines whether or not the screensaver of the video output equipment 11 has been activated. When the screens aver of the video output equipment 11 has been activated, the process proceeds to step S43. On the other hand, when the screensaver of the video output equipment 11 has not been activated, the process proceeds to step S44.

In step S43, the data recorder D3 stores the information indicating the activation of the screensaver of the video output equipment 11. The process proceeds to step S44.

In step S44, the calculation processor D1 determines whether or not there is a second signal input from the video output equipment 11 (for example, determines whether or not the video output equipment 11 is in a hibernation state). When there is no second signal (for example, when the video output equipment 11 is in the hibernation state), the process proceeds to step S45. On the other hand, when there is a second signal (for example, when the video output equipment 11 is not in the hibernation state), step S44 is iteratively executed.

In step S45, the video output equipment 11 is in the hibernation state (the output of the horizontal/vertical synchronization signal from the video output equipment 11 stops).

Subsequently, in step S46, the calculation processor D1 determines whether or not information indicating the activation of the screensaver of the video output equipment 11 has been stored in the data recorder D3. When the information indicating the activation of the screensaver of the video output equipment 11 has been stored in the data recorder D3, the process proceeds to step S47. On the other hand, when the information indicating the activation of the screensaver of the video output equipment 11 has not been stored in the data recorder D3, the process proceeds to step S49.

In step S47, the calculation processor D1 continues the video mute operation.

Subsequently, in step S48, the user of the video display device D issues a request for stopping the video mute operation. That is, the input manipulator 4 receives the request for stopping the video mute operation, the calculation processor D1 stops the video mute operation, and the process proceeds to step S49.

In step S49, the video display device D performs a non-signal display process.

### Fifth Embodiment

Hereinafter, a fifth embodiment of a video display device, a video display system, a video display method, and a program of the present invention will be described.

A video display device D of the fifth embodiment is configured like the video display device D of the fourth embodiment described above, except for differences to be described below. Therefore, according to the video display device D of the fifth embodiment, effects similar to those of the video display device D of the fourth embodiment described above can be obtained, except for the differences to be described below.

The video display device D of the fifth embodiment has a configuration substantially similar to that of the video display device D of the fourth embodiment shown in FIG. 6.

The video display device D of the fifth embodiment includes a calculation processor D1 and a display D2.

The calculation processor D1 analyzes a video signal input from video output equipment 11. The display D2 displays a video on the basis of a video signal input from video output equipment 11.

The calculation processor D1 executes a video mute operation on the basis of a video mute manipulation signal for requesting the video mute operation. Also, the calculation processor D1 determines whether or not the screensaver of the video output equipment 11 has been activated on the basis of a signal (a first signal) input from the video output equipment 11. The calculation processor D1 determines the presence/absence of a signal (a second signal) input from the video output equipment 11. The calculation processor 7 may determine that the video output equipment 11 is in a hibernation state when there is no second signal input from the video output equipment 11. The calculation processor D1 determines whether or not the information indicating the activation of the screensaver of the video output equipment 11 has been stored.

The calculation processor D1 determines to continue the video mute operation when the video mute operation has been requested, when it is determined that there is no second signal (for example, it is determined that the video output equipment 11 is in a hibernation state), and when it is determined that the information indicating the activation of the screensaver of the video output equipment 11 has been stored.

Although modes for carrying out the present invention have been described using embodiments, the present invention is not limited to the embodiments and various modifications and substitutions can also be made without departing from the scope and spirit of the present invention. The configurations described in the embodiments and the examples described above may be combined.

All or some functions of the parts provided in the video display system 100 or the video display system S according to the above-described embodiment may be implemented by recording a program for implementing the functions on a computer-readable recording medium and causing a computer system to read and execute the program recorded on the recording medium. Also, the “computer system” described here is assumed to include an OS and hardware such as peripheral devices.

Also, the “computer-readable recording medium” refers to a flexible disk, a magneto-optical disc, a read-only memory (ROM), a portable medium such as a compact disc (CD)-ROM, or a storage such as a hard disk embedded in the computer system. Further, the “computer-readable recording medium” may include a computer-readable recording medium for dynamically retaining the program for a short period of time as in a communication line when the program is transmitted via a network such as the Internet or a communication circuit such as a telephone circuit and a computer-readable recording medium for retaining the program for a given period of time as in a volatile memory inside the computer system including a server and a client when the program is transmitted. Also, the above-described program may be a program for implementing some of the above-described functions. Further, the above-described program may be a program capable of implementing the above-described function in combination with a program already recorded on the computer system.

### REFERENCE SIGNS LIST

1 Light source

2 Light source controller

3 Manipulation receiver

4 Input manipulator

5 Projection device

6 Video processor

7 Calculation processor

8 Data recorder

9 Lens group in main body

10 Video input

11 Video output equipment

11A Screensaver detector

11B Communication controller

12 Video display device

12A Display

12B Communication controller

13 Video projection target

100 Video display system

D Video display device

D1 Calculation processor

D2 Display

D3 Data recorder

D4 Manipulation receiver

D5 Video input

S Video display system

1. A video display device comprising:
a calculation processor configured to analyze a video signal input from video output equipment; and
a display configured to display a video on the basis of the video signal input from the video output equipment,
wherein the calculation processor
executes a video mute operation on the basis of a video mute manipulation signal for requesting the video mute operation,
determines whether or not a screensaver of the video output equipment has been activated on the basis of a first signal input from the video output equipment,
determines the presence or absence of a second signal to be input from the video output equipment, and
determines whether or not information indicating the activation of the screensaver of the video output equipment has been stored, and
wherein the calculation processor determines to continue the video mute operation when the video mute operation has been requested, when it is determined that there is no second signal, and when it is determined that the information indicating the activation of the screensaver of the video output equipment has been stored.

2. The video display device according to claim 1,
wherein, before the presence or absence of the second signal is determined when the video mute operation has been requested,
the calculation processor
executes a process of discarding the information indicating the activation of the screensaver of the video output equipment and
determines whether or not the screensaver of the video output equipment has been activated.

3. A video display system comprising:
the video display device according to claim 1;
the video output equipment; and
an input manipulator configured to transmit the video mute manipulation signal.

4. The video display system according to claim 3,
wherein the video output equipment comprises:
a screensaver detector configured to detect the activation of the screensaver; and
a first communication controller configured to transmit a signal indicating the activation of the screensaver detected by the screensaver detector, and
wherein the video display device comprises:
a second communication controller configured to receive the signal indicating the activation of the screensaver transmitted by the first communication controller.

5. A video display method comprising:
displaying a video on the basis of a video signal input from video output equipment;
executing a video mute operation on the basis of a video mute manipulation signal for requesting the video mute operation;
determining whether or not a screensaver of the video output equipment has been activated on the basis of a first signal input from the video output equipment;
determining the presence or absence of a second signal to be input from the video output equipment;
determining whether or not information indicating the activation of the screensaver of the video output equipment has been stored; and
determining whether or not to continue the video mute operation,
wherein, when it is determined whether or not to continue the video mute operation, it is determined to continue the video mute operation when the video mute operation has been requested, when it is determined that there is no second signal, and when it is determined that the information indicating the activation of the screensaver of the video output equipment has been stored.

6. A non-transitory computer readable recording medium storing a program which makes a computer implement:
displaying a video on the basis of a video signal input from video output equipment;
executing a video mute operation on the basis of a video mute manipulation signal for requesting the video mute operation;
determining whether or not a screensaver of the video output equipment has been activated on the basis of a first signal input from the video output equipment;
determining the presence or absence of a second signal to be input from the video output equipment;
determining whether or not information indicating the activation of the screensaver of the video output equipment has been stored; and
determining whether or not to continue the video mute operation,
wherein, when determining whether or not to continue the video mute operation, it is determined to continue the video mute operation when the video mute operation has been requested, when it is determined that there is no second signal, and when it is determined that the information indicating the activation of the screensaver of the video output equipment has been stored.
